(19) United States
(12) Patent Application Publication
(10) Pub. No.: US 2025/0234249 A1
(43) Pub. Date: Jul. 17, 2025

(54) SYSTEMS AND METHODS FOR DYNAMICALLY MANAGING SERVICE LEVELS IN A WIRELESS NETWORK

(71) Applicant: T-Mobile Innovations LLC, Overland Park, KS (US)

(72) Inventors: Anil Kumar MARIYANI, Ashburn, VA (US); Subramania KAUSHIK, Bellevue, WA (US); Chris JENSEN, Snoqualmie, WA (US)

(21) Appl. No.: 18/413,661

(22) Filed: Jan. 16, 2024

(51) Int. Cl. H04W 28/24; H04W 28/08

(52) U.S. Cl. CPC H04W 28/24; H04W 28/0925; H04W 28/0967

(57) ABSTRACT

Systems and methods are provided for dynamically managing service levels in a wireless network. Methods include receiving, by a UDM, from a UDR, existing service levels for one or more wireless devices. The methods further include receiving, by the UDM, from the UDR, UDSP rules for the one or more wireless devices. The methods further include applying the UDSP rules to the existing service levels to yield resultant service levels for the one or more wireless devices.

### TECHNICAL BACKGROUND

A wireless network, such as a cellular network, can include an access node (e.g., base station) serving multiple wireless devices or user equipment (UE) in a geographical area covered by a radio frequency transmission provided by the access node. Access nodes may deploy different carriers within the cellular network utilizing different types of radio access technologies (RATs). RATs can include, for example, 3G RATs (e.g., GSM, CDMA etc.), 4G RATs (e.g., WiMax, LTE, etc.), and 5G RATs (new radio (NR)). RATS may additionally include, for example, Wi-Fi and Bluetooth. Additionally, different standards may be implemented, including one or more International Engineering Task Force (IETF) standards; one or more of the Institute of Electrical and Electronics Engineers (IEEE) 802.11 standards; and/or any other industry standards and/or specifications. Further, different types of access nodes may be implemented for deployment for the various RATs. For example, an evolved NodeB (eNodeB or eNB) may be utilized for 4G RATs and a next generation NodeB (gNodeB or gNB) may be utilized for 5G RATs. Deployment of the evolving RATs in a network provides numerous benefits. For example, newer RATs may provide additional resources to subscribers, faster communications speeds, and other advantages. For example, 5G networks provide edge deployments enabling computing capabilities closer to UEs.

As wireless networks evolve and grow, the number and types of services provided by wireless carriers grows and changes as well. Some carriers may provide one set of services, while other carriers may provide a different set of services. Carriers from different regions may have contracts with foreign carriers to provide roaming service to their customers. Carriers typically provide different levels of service to different customers based on different subscription rate plans. Managing the different service levels is currently a difficult process with many inefficiencies.

### Overview

Examples described herein include systems and methods for dynamically managing service levels in a wireless network. An exemplary method includes receiving, by a Unified Data Management device (UDM), from a Unified Data Repository (UDR), existing service levels for one or more wireless device. The method further includes receiving, by the UDM, from the UDR, User Dependent Subscriber Profile (UDSP) rules for the one or more wireless devices. The method further includes applying the UDSP rules to the existing service levels to yield resultant service levels for the one or more wireless devices.

Another exemplary embodiment includes a system including a Unified Data Repository UDR), a Unified Data Management device (UDM) which includes at least one electronic processor configured to perform operations. The operations include receiving, by the UDM, from the UDR, existing service levels for one or more wireless devices. The operations further include receiving, by the UDM, from the UDR, User Dependent Subscriber Profile (UDSP) rules for the one or more wireless devices. The operations further include applying the UDSP rules to the existing service levels to yield resultant service levels for the one or more wireless devices.

Another exemplary embodiment includes a method of dynamically managing service levels in a wireless network. The method includes receiving, by a Unified Data Management device (UDM), Shared Data Support (SDS) data sets for one or more wireless devices from a Unified Data Repository (UDR). The method further includes receiving, by the UDM, User Dependent Subscriber Profile (UDSP) rules for the one or more wireless devices. The method further includes applying the UDSP rules to the SDS data sets to yield resultant data sets for the one or more wireless device. The method further includes providing services to the one or more wireless devices in accordance with service levels indicated in the resultant data sets.

### BRIEF DESCRIPTION OF THE DRAWINGS

These and other more detailed and specific features of various embodiments are more fully disclosed in the following description, reference being had to the accompanying drawings, in which:

FIG. 1 illustrates an exemplary system for dynamically managing service levels in a wireless network in accordance with various aspects of the present disclosure;

FIG. 2 illustrates an exemplary processing node in accordance with various aspects of the present disclosure;

FIG. 3 illustrates an exemplary process flow for dynamically managing service levels in a wireless network; and

FIG. 4 illustrates an exemplary process flow for dynamically managing service levels in a wireless network.

### DETAILED DESCRIPTION

In the following description, numerous details are set forth, such as flowcharts, schematics, and system configurations. It will be readily apparent to one skilled in the art that these specific details are merely exemplary and not intended to limit the scope of this application.

In accordance with various aspects of the present disclosure, a wireless network may be provided by a wireless provider. A wireless provider may provide many services, and each may have different service levels. For example, a wireless provider may provide data services that can be used for Internet access and that service may be limited by a maximum allowed data speed or bit rate. The 3GPP has defined Shared Data Support (SDS) as a method of controlling which services are available and any restrictions on those services, amongst other things. SDS is discussed in specifications 23.501, 23.502 and 29.503. Table 1, below shows some of the existing SDS data sets.

TABLE 1

| Shared Data Types | Description |
|---|---|
| sharedAmData | Shared Access and Mobility |
| | Subscription Data |
| sharedSmsSubs Data | Shared SMS Subscription Data |
| sharedSmsMngSubsData | Shared SMS Management |
| | Subscription Data |
| sharedDnnConfigurations | Shared DNN configurations |
| sharedTraceData | Shared Trace Data |
| sharedSnssaiInfos | Shared Snssai Infos |
| sharedVnGroupDatas | A map of shared 5G VN group data |

SDS defines, for example, a shared data set called “sharedDnnConfigurations” and one attribute within that data set is “sessionAmbr” which sets a maximum aggregated uplink and downlink bit rate. There are many shared data sets, each with many attributes, with just one example given above. Table 2, below shows the attributes for the “sharedDnnConfigurations” data set.

TABLE 2

| SI. No | Attribute name | Description |
|---|---|---|
| 1 | pduSessionTypes | Default/Allowed session types |
| 2 | sscModes | Default/Allowed SSC modes |
| 3 | iwkEpsInd | Indicates whether interworking with EPS is subscribed: |
| | | true: Subscribed; |
| | | false: Not subscribed; |
| | | If this attribute is absent, it means not subscribed. |
| 4 | 5gQosProfile | 5G QoS parameters associated to the session for a data |
| | | network |
| 5 | sessionAmbr | The maximum aggregated uplink and downlink bit rates to be |
| | | shared across all Non-GBR QoS Flows in each PDU Session |
| 6 | 3gppChargingCharacteristics | Subscribed charging characteristics data associated to the |
| | | session for a data network. (NOTE) |
| 7 | staticIpAddress | Subscribed static IP address(es) of the IPv4 and/or IPv6 type |
| 8 | upSecurity | When present, this IE shall indicate the security policy for |
| | | integrity protection and encryption for the user plane. |
| 9 | pduSessionContinuityInd | When present, this IE shall indicate how to handle a PDU |
| | | Session when UE the moves to or from NB-IoT. |
| | | If this attribute is absent, it means Local policy shall be used. |
| 10 | invokeNefSelection | When present, this IE shall indicate whether to invoke NEF |
| | | selection for NIDD session: |
| | | true: to invoke the NEF selection. |
| | | false or absent: not to invoke the NEF selection. |
| | | If this attribute is absent, it means not to invoke the NEF |
| | | selection. |
| 11 | niddNefld | Indicates the identity of the NEF to be selected for NIDD |
| | | service for this DNN. It is required if invokeNefSelection |
| | | attribute is present with value “true”. |
| 12 | niddInfo | When present, this IE shall indicate information used for SMF- |
| | | NEF Connection. |
| | | This attribute may be present if “Invoke NEF Selection” |
| | | indicator is set. |
| 13 | redundantSessionAllowed | Indicates whether redundant PDU Sessions are allowed: |
| | | true: Allowed; |
| | | false: Not allowed; |
| | | If this attribute is absent it means not allowed. |
| 14 | acsInfo | When present, this IE shall include the ACS information for the |
| | | 5G-RG as defined in BBF TR-069 [42] or in BBF TR-369 [43]. |
| 15 | ipv4FrameRouteList | List of Frame Route information of IPv4, see clause 5.6.14 of |
| | | 3GPP TS 23.501 [2]. |
| 16 | ipv6FrameRouteList | List of Frame Route information of IPv6, see clause 5.6.14 of |
| | | 3GPP TS 23.501 [2]. |
| 17 | atsssAllowed | Indicates whether this DNN supports ATSSS, i.e. whether |
| | | Multi-Access PDU session is allowed to this DNN. |
| | | true: Allowed; |
| | | false (default): Not allowed; |
| | | If this attribute is absent, it means this DNN does not allow |
| | | ATSSS. |

SDS can be used to allow or deny services or it can be used to limit services like in the example given above. One common use of SDS is for wireless device roaming. A wireless device will have a Home Public Land Mobile Network (H-PLMN) which is for when the wireless device is within the network of the wireless provider the wireless device is subscribed to. The wireless device may have a set of SDS information that applies when the wireless device is within the H-PLMN. A wireless device will also have a Visiting PLMN (V-PLMN) for when the wireless device is roaming outside of its subscribed provider's network, when visiting another country, for example. There may be a different set of SDS information that applies when the wireless device is roaming and is therefore in a V-PLMN. In this way SDS assignments are based on the attached PLMN IDs. The provider would thus be able to set different service levels for their subscribing wireless devices based on whether they are roaming or not. For example, a subscriber might have Internet access at a high maximum bit rate while within the provider's network but may have a lower maximum bit rate or may be denied Internet access while roaming on a different provider's network.

SDS attributes are set during provisioning and are slow and difficult to update, often requiring access to the providers provisioning system and human intervention. There is no concept available to induce/replace/suppress 5G provisioning attributes under SDS or any concept available to modify the already provisioned static 5G subscription parameters with new values dynamically. There may be times when a provider will want to dynamically update SDS attributes for a wireless device or for a set of wireless devices. For example, if the provider is experiencing a temporary network problem in a particular cell, they may want to reduce the maximum bit rate for wireless devices in that cell until the problem is fixed. Quickly changing a service level for a short period of time such as in this example may not be possible with the existing methods of updating SDS attributes.

A novel method of providing updates to the service levels of wireless devices is using User Dependent Subscriber Profile (UDSP) rules. UDSP rules may be configured to induce an attribute, replace an attribute, or suppress an attribute from the attributes found in the SDS data sets. When a set of UDSP rules are applied to an existing SDS data set to get a resultant data set, that resultant data set may then be propagated to the other functions of the wireless network, such as the AMF, SMF, SMSF or any other network function that needs this information. An SDS data set may have not defined an attribute value for a particular attribute. When applying a UDSP rule set to the SDS data sets, a value for the previously undefined attribute may be induced, thus dynamically changing the service level being provided to the wireless device. This could be used to add a restriction to a previously unrestricted service, for example. Similarly, the SDS data sets may provide a value for a specific attribute and applying a UDSP ruleset could replace the attribute value for the wireless device. For example, the SDS data set may define a value of 1 Gbps for “sessionAmbr”, but the UDSP ruleset could replace that with a value of 500 Mbps. Therefore, while the UDSP rules were in effect for a wireless device, the maximum aggregated bit rate for the wireless device would be 500 Mbps, not the previous 1 Gbps. Similarly, the UDSP rules could be used to suppress a particular attribute from the SDS data sets. Following the above example, the UDSP rules could suppress the “sessionAmbr” attribute, thus removing any bit rate limit for the wireless device. The UDSP rules may therefore be used to increase or decrease service levels for the wireless device, including imposing a new service level restriction or removing an existing service level restriction. Service level changes could include providing a new service or denying access to a service the wireless device previously had access to. These service level changes may be applied dynamically and need not be propagated back to the SDS data sets stored in the UDR. This gives significant flexibility to the wireless provider to solve various day-to-day issues with wireless devices or the wireless network.

As previously mentioned, a wireless provider may want to provide different service levels to a wireless device depending on whether the wireless device is roaming or not. This can be accomplished dynamically with the UDSP rules being selectively applied based on the current PLMN of the wireless device. The provider may want UDSP rules to apply in other situations as well. For example, the UDSP rules could be applied for specific device types. This could be accomplished using The Type Allocation Code (TAC) portion of the IMEI. Other examples include applying UDSP rules for specific subscribers using the billing ID, for specific devices in a particular network slice using the slice ID or for devices in a particular location or region. The UDSP rules may also be dynamically applied based on any combination of the above criteria. For example, roaming wireless devices of a particular brand and model that are accessing the providers network from a particular region could have their service levels controlled by a particular set of UDSP rules different from other brands of devices even in the same region.

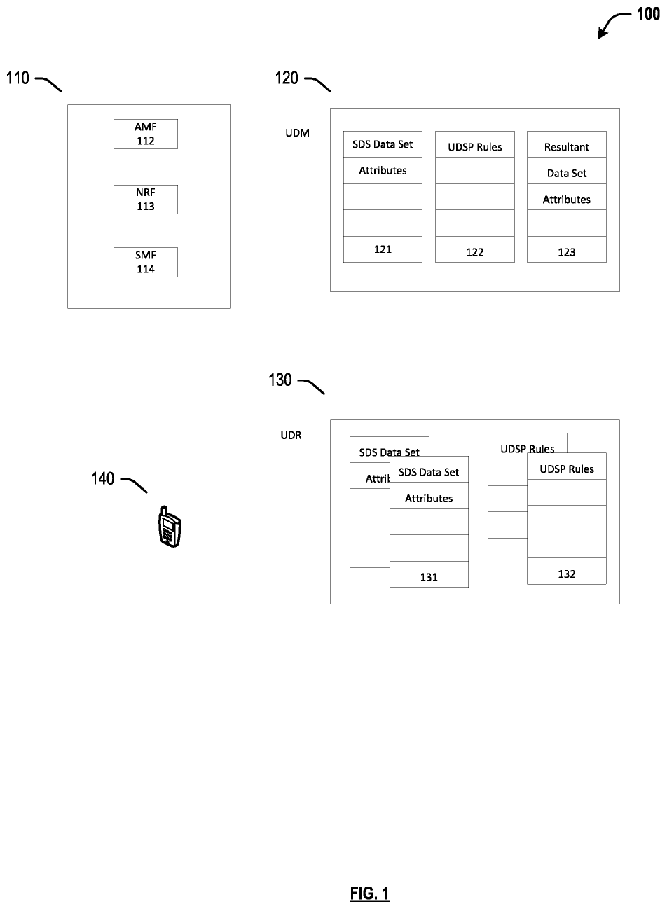

FIG. 1 depicts an exemplary system 100 for dynamically managing service levels in a wireless network. System 100 includes a number of network functions 110 including an Access and Mobility Management Function (AMF) 112, a Network Repository Function (NRF) 113 and a Session Management Function (SMF) 114. These three network functions 110 are shown as examples of the many network functions present in a wireless network. The system 100 also includes a Unified Data Management function (UDM) 120. Within the UDM 120 are shown a SDS data set and its attributes 121, the UDSP rules 122 and the resultant data set and its attributes 123. The system 100 also includes a Unified Data Repository (UDR) 130. Within the UDR 130 are shown multiple SDS data sets and their attributes 131 as well as multiple sets of UDSP rules 132. Also shown within system 100 is an exemplary wireless device 140. Although one UDM 120, UDR 130 and wireless device 140 are depicted, it is understood that many of each may be included and only one of each is shown for clarity.

Wireless device 140 may be any device, system, combination of devices, or other such communication platform capable of communicating on the wireless network using one or more frequency bands deployed therefrom. Each wireless device 140 may be, for example, a mobile phone, a wireless phone, a wireless modem, a personal digital assistant (PDA), a voice over internet protocol (VOIP) phone, a voice over packet (VOP) phone, or a soft phone, as well as other types of devices or systems that can exchange audio or data via the wireless network. Other types of communication platforms are possible.

In operation, the system 100 may be configured such that the UDM 120 receives from the UDR 130 the existing service levels for the wireless device 140 such as those represented by the SDS data set 121. The UDM 120 also receives from the UDR 130 UDSP rules 122 for the wireless device 140. The UDM 120 may then apply the UDSP rules 122 to the existing service levels to yield the resultant service levels represented here by the resultant data set 123. Service may then be provided to the wireless device 140 in accordance with the resultant data set and its attributes 123.

Other network elements may be present in system 100 to facilitate communication but are omitted for clarity, such as access nodes, base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements.

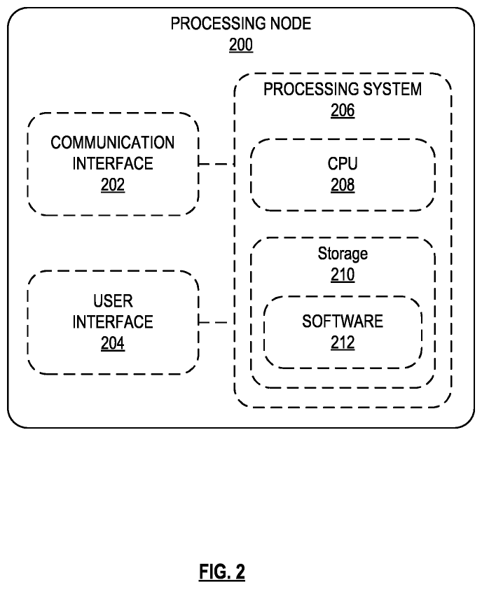

FIG. 2 depicts an exemplary processing node 200 for managing authentication of wireless devices in a wireless network. The processing node 200 includes a communication interface 202, user interface 204, and processing system 206 in communication with communication interface 202 and user interface 204. Processing system 206 includes a processor 208, storage 210, which can comprise a disk drive, flash drive, memory circuitry, or other memory device including, for example, a buffer. Storage 210 can store software 212 which is used in the operation of the processing node 200. Software 212 may include computer programs, firmware, or some other form of machine-readable instructions, including an operating system, utilities, drivers, network interfaces, applications, or some other type of software. Processing system 206 may include a microprocessor 208 and other circuitry to retrieve and execute software 212 from storage 210. Processing node 200 may further include other components such as a power management unit, a control interface unit, etc., which are omitted for clarity. Communication interface 202 permits processing node 200 to communicate with other network elements. User interface 204 permits the configuration and control of the operation of processing node 200. Processing node 200 may be a part of a network function server such as UDM 120.

In an exemplary embodiment, software 212 can include instructions for receiving, by a UDM, from a UDR, existing service levels for one or more wireless devices. The instructions may further include receiving, by the UDM, from the UDR, UDSP rules for the one or more wireless devices. The instructions may further include applying the UDSP rules to the existing service levels to yield resultant service levels for the one or more wireless devices.

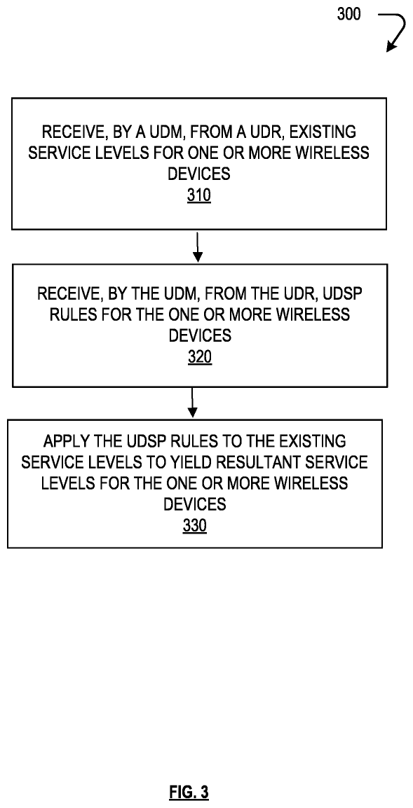

FIG. 3 illustrates an exemplary method 300 for managing service levels in a wireless network. Method 300 may be performed by any suitable combination of processors, for example processing node 200. Although FIG. 3 depicts steps performed in a particular order for purposes of illustration and discussion, the operations discussed herein are not limited to any particular order or arrangement. One skilled in the art, using the disclosures provided herein, will appreciate that various steps of the methods can be omitted, rearranged, combined, and/or adapted in various ways.

Method 300 begins at step 310 where a UDM receives from a UDR existing service levels for one or more wireless devices. Method 300 continues at step 320 where the UDM receives from the UDR UDSP rules for the one or more wireless devices. Method 300 continues at step 330 as the UDSP rules are applied to the existing service levels to yield resultant service levels for the one or more wireless devices, Service may then be provided to the one or more wireless devices in accordance with the resultant service levels. The UDSP rules may be applied based on one or more of a PLMN, a wireless device type, a billing ID, a network slice ID and a subscriber location of the one or more wireless devices. Applying the UDSP rules may result in increasing or decreasing the service level provided to the one or more wireless devices. It may even result in the one or more wireless devices being denied a particular service or services. Similarly, applying the UDSP rules may result in the one or more wireless devices having access to a service that they previously did not. The UDSP rules may be applied yielding the resultant service levels without the resultant service levels being propagated back to the SDS data sets stored in the UDR.

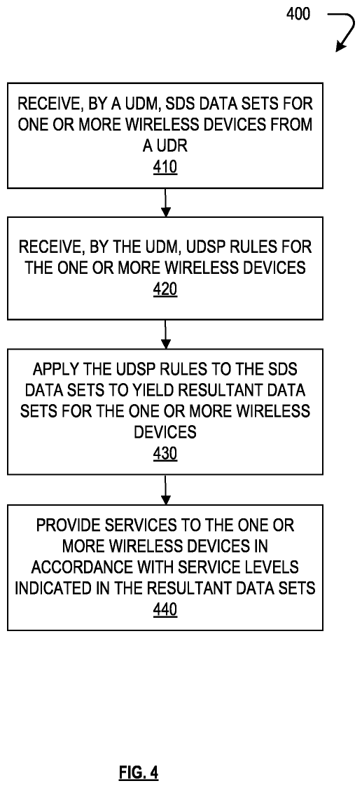

FIG. 4 illustrates an exemplary method 400 for managing service levels in a wireless network. Method 400 may be performed by any suitable combination of processors, for example processing node 200. Although FIG. 4 depicts steps performed in a particular order for purposes of illustration and discussion, the operations discussed herein are not limited to any particular order or arrangement. One skilled in the art, using the disclosures provided herein, will appreciate that various steps of the methods can be omitted, rearranged, combined, and/or adapted in various ways.

Method 400 begins at step 410 where a UDM receives from a UDR SDS data sets for one or more wireless devices. Method 400 continues at step 420 where the UDM receives from the UDR UDSP rules for the one or more wireless devices. Method 400 continues at step 430 as the UDSP rules are applied to the SDS data sets to yield resultant data sets for the one or more wireless devices. Method 400 continues at step 440 where service is provided to the one or more wireless devices in accordance with the resultant data sets. The UDSP rules may be applied based on one or more of a PLMN, a wireless device type, a billing ID, a network slice ID and a subscriber location of the one or more wireless devices. Applying the UDSP rules may assign a value to an SDS attribute without a current value. Applying the UDSP rules may modify an existing value at an SDS attribute. Applying the UDSP rules may also delete an existing value at an SDS attribute. Applying the UDSP rules may result in increasing or decreasing the service level provided to the one or more wireless devices. It may even result in the one or more wireless devices being denied a particular service or services. Similarly, applying the UDSP rules may result in the one or more wireless devices having access to a service that they previously did not. The UDSP rules may be applied yielding the resultant data sets without the resultant data sets being propagated back to the SDS data sets stored in the UDR.

In some embodiments, methods 300 and 400 may include additional steps or operations. Furthermore, the methods may include steps shown in each of the other methods. As one of ordinary skill in the art would understand, the methods of 300 and 400 may be integrated in any useful manner and the steps may be performed in any useful sequence.

Communication between components may be by way or wired or wireless networks. Wireless network protocols can comprise Multimedia Broadcast Multicast Services (MBMS), code division multiple access (CDMA) 1×RTT, Global System for Mobile communications (GSM), Universal Mobile Telecommunications System (UMTS), High-Speed Packet Access (HSPA), Evolution Data Optimized (EV-DO), EV-DO rev. A, Third Generation Partnership Project Long Term Evolution (3GPP LTE), and Worldwide Interoperability for Microwave Access (WiMAX), Fourth Generation broadband cellular (4G, LTE Advanced, etc.), and Fifth Generation mobile networks or wireless systems (5G, 5G New Radio (“5G NR”), or 5G LTE). Wired network protocols that may be utilized for communication between components comprise Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM). The wireless network can also comprise additional base stations, controller nodes, telephony switches, internet routers, network gateways, computer systems, communication links, or some other type of communication equipment, and combinations thereof.

Communication between components can use various communication media, such as air, space, metal, optical fiber, or some other signal propagation path-including combinations thereof. Communication between components can be wired or wireless and use various communication protocols such as Internet, Internet protocol (IP), local-area network (LAN), optical networking, hybrid fiber coax (HFC), telephony, T1, or some other communication format-including combinations, improvements, or variations thereof. Wireless communication links can be a radio frequency, microwave, infrared, or other similar signal, and can use a suitable communication protocol, for example, Global System for Mobile telecommunications (GSM), Code Division Multiple Access (CDMA), Worldwide Interoperability for Microwave Access (WiMAX), Long Term Evolution (LTE), 5G NR, or combinations thereof. Other wireless protocols can also be used. Communication between components can be a direct link or might include various equipment, intermediate components, systems, and networks. Communication between components may comprise many different signals sharing the same link.

The exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid-state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of dynamically managing service levels in a wireless network, the method comprising:
receiving, by a Unified Data Management device (UDM), from a Unified Data Repository (UDR), existing service levels for one or more wireless devices;
receiving, by the UDM, from the UDR, User Dependent Subscriber Profile (UDSP) rules for the one or more wireless devices; and
applying the UDSP rules to the existing service levels to yield resultant service levels for the one or more wireless devices.

2. The method of claim 1, wherein the UDSP rules are applied based on one or more of: a PLMN, a wireless device type, a billing ID, a network slice ID, and a subscriber location of the one or more wireless devices.

3. The method of claim 1, wherein the UDSP rules decrease a service level of the one or more wireless devices.

4. The method of claim 3, wherein decreasing the service level of the one or more wireless devices comprises denying the one or more wireless devices access to one or more services.

5. The method of claim 1, wherein the UDSP rules increase a service level of the one or more wireless devices.

6. The method of claim 5, wherein increasing the service level of the one or more wireless device comprises adding a new service to the one or more wireless devices.

7. The method of claim 1, wherein the UDSP rules are applied without updating the existing service levels at the UDR.

8. The method of claim 1, the method further comprising:
providing services to the one or more wireless devices in accordance with service levels indicated in the resultant service levels.

9. A system comprising:
a Unified Data Repository (UDR); and
a Unified Data Management device (UDM), including at least one processor configured to perform operations, the operations comprising:
receiving, by the UDM, from the UDR, existing service levels for one or more wireless devices;
receiving, by the UDM, from the UDR, User Dependent Subscriber Profile (UDSP) rules for the one or more wireless devices; and
applying the UDSP rules to the existing service levels to yield resultant service levels for the one or more wireless devices.

10. The system of claim 9, wherein the UDSP rules are applied based on one or more of: a PLMN, a wireless device type, a billing ID, a network slice ID, and a subscriber location of the one or more wireless devices.

11. The system of claim 9, wherein the UDSP rules decrease a service level of the one or more wireless devices.

12. The system of claim 11, wherein decreasing the service level of the one or more wireless devices comprises denying the one or more wireless devices access to one or more services.

13. The system of claim 9, wherein the UDSP rules increase a service level of the one or more wireless devices.

14. The system of claim 9, the operations further comprising:
providing services to the one or more wireless devices in accordance with service levels indicated in the resultant service levels.

15. A method of dynamically managing service levels in a wireless network, the method comprising:
receiving, by a Unified Data Management device (UDM), Shared Data Support (SDS) data sets for one or more wireless devices from a Unified Data Repository (UDR);
receiving, by the UDM, User Dependent Subscriber Profile (UDSP) rules for the one or more wireless devices;
applying the UDSP rules to the SDS data sets to yield resultant data sets for the one or more wireless device; and
providing services to the one or more wireless devices in accordance with service levels indicated in the resultant data sets.

16. The method of claim 15, wherein the UDSP rules are applied based on one or more of: a PLMN, a wireless device type, a billing ID, a network slice ID, and a subscriber location of the one or more wireless devices.

17. The method of claim 15, wherein applying the UDSP rules assigns a value to an SDS attribute without a current value.

18. The method of claim 15, wherein applying the UDSP rules modify a value at an SDS attribute with a current value.

19. The method of claim 15, wherein applying the UDSP rules deletes a value at an SDS attribute with a current value.

20. The method of claim 15, wherein the UDSP rules are applied without updating the SDS data sets at the UDR.
